(19) United States
(12) Patent Application Publication
(10) Pub. No.: US 2025/0108627 A1
(43) Pub. Date: Apr. 3, 2025

(54) INKJET IMAGE FORMING APPARATUS

(71) Applicant: KYOCERA Document Solutions Inc., Osaka (JP)

(72) Inventor: Nobuhiro MAEZAWA, Osaka-shi (JP)

(73) Assignee: KYOCERA Document Solutions Inc., Osaka (JP)

(21) Appl. No.: 18/888,788

(22) Filed: Sep. 18, 2024

(30) Foreign Application Priority Data
Sep. 28, 2023 (JP) 2023-166642

(51) Int. Cl. B41J 2/21; B41M 5/00

(52) U.S. Cl. CPC B41J 2/2114; B41M 5/0017; B41M 5/0047; B41M 5/0064

(57) ABSTRACT

An inkjet image forming apparatus includes an image part, a precoating unit, and a control part. The image forming part ejects ink on a printing base material conveyed in a predetermined conveyance direction, based on image data to form an image. The precoating unit is arranged on an upstream side of the image forming part in the conveyance direction, and performs a precoating treatment in which a precoating liquid is ejected on the printing base material. The control part controls an amount of the precoating liquid ejected by the precoating unit. The control part increases an amount of the precoating liquid ejected to a region where adjacent pixels have different color compared with an amount of the precoating liquid ejected to a region where adjacent pixels have the same color.

### INCORPORATION BY REFERENCE

This application is based on and claims the benefit of priority from Japanese patent application No.2023-166642 Sep. 28, 2023, which is incorporated by reference in its entirety.

### BACKGROUND

The present disclosure relates to an inkjet image forming apparatus which forms an image on a printing base material by an inkjet method.

In the inkjet type image forming apparatus, in order to enhance an adhesion of ink to the printing base material, a precoating treatment (pre-treatment) may be applied to the printing base material.

In the precoating treatment, an application amount of a precoating liquid may be determined based on a type of the ink and an adhesion amount per unit area of the ink ejected onto the printing base material. In the precoating treatment, a pretreatment liquid for insolubilizing or flocculating a color material in the ink may be used.

However, when the printing base material is a plastic film having a smooth surface, the ink landed on the printing base material tends to move. Therefore, even if the precoating treatment is performed as described above, image defects such as color mixing due to the movement of the landed ink are likely to occur.

### SUMMARY

An inkjet image forming apparatus according to the present disclosure includes an image part, a precoating unit, and a control part. The image forming part ejects ink on a printing base material conveyed in a predetermined conveyance direction, based on image data to form an image. The precoating unit is arranged on an upstream side of the image forming part in the conveyance direction, and performs a precoating treatment in which a precoating liquid is ejected on the printing base material. The control part controls an amount of the precoating liquid ejected by the precoating unit. The control part increases an amount of the precoating liquid ejected to a region where adjacent pixels have different color compared with an amount of the precoating liquid ejected to a region where adjacent pixels have the same color.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inkjet image forming apparatus according to one embodiment of the present disclosure.

FIG. 2 is a plan view showing a head unit, in the inkjet image forming apparatus according to the embodiment of the present disclosure.

FIG. 3 is a diagram explaining a landed ink, in the inkjet image forming apparatus according to the embodiment of the present disclosure.

FIG. 4 is a table showing a result for observing a degree of color mixing, in the inkjet image forming apparatus according to the embodiment of the present disclosure.

FIG. 5A shows an image in the present example, in the inkjet image forming apparatus according to the embodiment of the present disclosure.

FIG. 5B shows an image in the comparative example, in the inkjet image forming apparatus according to the embodiment of the present disclosure.

### DETAILED DESCRIPTION

Hereinafter, an inkjet image forming apparatus according to one embodiment of the present disclosure will be described with reference to the drawings.

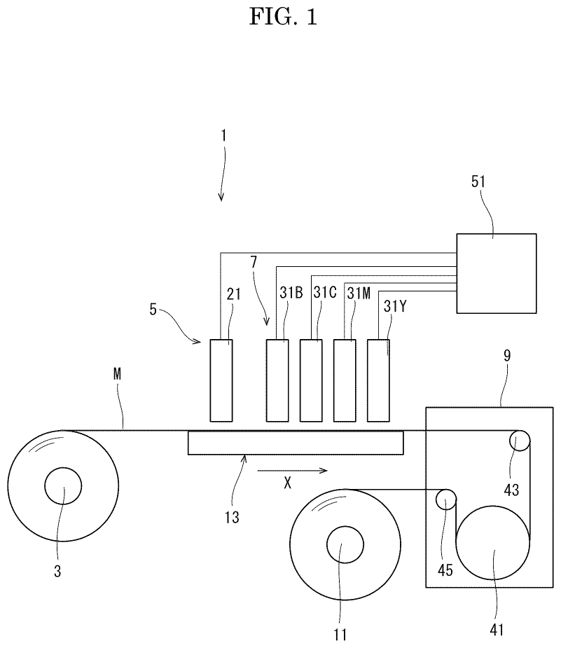

With reference to FIG. 1, the entire structure of the inkjet image forming apparatus 1 will be described. FIG. 1 is a front view schematically showing an internal structure of the inkjet image forming apparatus 1.

The inkjet image forming apparatus 1 includes a feed roller 3, a precoating unit 5, an image forming part 7, a drying part 9, and a rewinding roller 11, in the order along a conveyance direction of a printing base material M. The inkjet image forming apparatus 1 further includes a conveying plate 13 disposed below the precoating unit 5 and the image forming part 7 between the feed roller 3 and the drying part 9.

First, the feed roller 3 will be described. A long printing base material M is wound around the feed roller 3. When the feed roller 3 is rotated, the printing base material M is fed out in the conveyance direction X.

Next, the precoating unit 5 will be described. The precoating unit 5 applies a precoating treatment to the printing base material M fed from the feed roller 3. The precoating unit 5 includes a precoating head unit 21 which ejects a precoating liquid. The precoating head unit 21 is electrically connected to a control part 51.

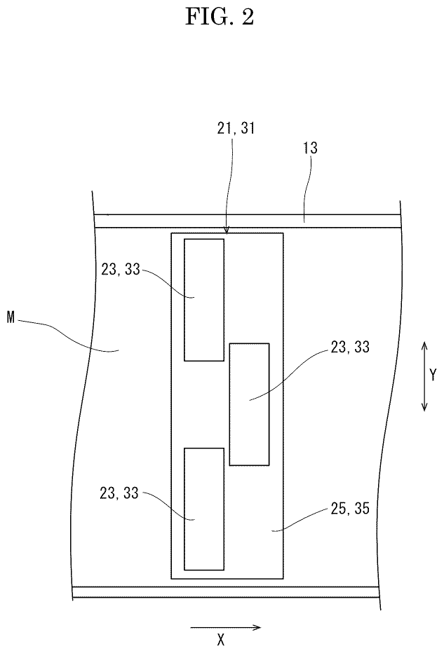

With reference to FIG. 2, the precoating head unit 21 will be described. FIG. 2 is a plan view showing the precoating head unit 21. The precoating head unit 21 is provided with three print heads 23 and a plate 25 for supporting the three print heads 23. The three print heads 23 are disposed in a staggered pattern along the width direction Y (intersecting the conveyance direction X) so as to have a length approximately equal to the width of the printing base material M (line head system), and are supported by the plate 25. A precoating liquid is supplied from a precoating liquid supply source to the three print heads 23.

The print head 23 includes a large number of nozzles and piezoelectric element provided in each nozzle. The ejection port of the nozzle is opened on the lower surface of the print head 23. The piezoelectric element is deformed by applying a voltage to the piezoelectric element, and the precoating liquid in the nozzle is ejected downward through the ejection port.

The components of the precoating liquid are, for example, 10% polyester resin (Trade name, PESRESIN A-640, manufactured by TAKAMATSU OIL & HAT CO., LTD.), 0.04% surfactant (Trade name, Surfynol 440, manufactured by Nisshin Chemical co., ltd.), 25% propylene glycol, and 64.96% water.

Next, the image forming part 7 will be described with reference to FIG. 1. The image forming part 7 forms an image on the printing base material M by an inkjet method. The image forming part 7 includes four image forming head units 31B, 31C, 31M, and 31Y (collectively referred to as the image forming head unit 31) corresponding to the inks of four colors (black, cyan, magenta, and yellow). The four image forming head units 31 are arranged in order along the conveyance direction X. The four image forming head units 31 are electrically connected to the control part 51.

The image forming head unit 31 has the same configuration as the precoating head unit 21 of the precoating unit 5 shown in FIG. 2, and includes the three print heads 33 and the plate 35 for supporting the three print heads 33. The black, cyan, magenta, and yellow inks are supplied to the three print heads 33 of the four image forming head units 31, respectively.

The print head 33 includes a large number of nozzles and piezoelectric elements provided in each nozzle. The ejection port of the nozzle is opened on the lower surface of the print head 33. The piezoelectric element is deformed by applying a voltage to the piezoelectric element, and the ink in the nozzle is ejected downward from the ejection port.

Next, the drying part 9 will be described with reference to FIG. 1. The drying part 9 dries the image formed on the printing base material M in the image forming part 7. The drying part 9 includes a heat drum 41, and upstream-side and downstream-side tension rollers 43 and 45 arranged on the upstream side and the downstream side of the heat drum 41. The printing base material M passing through the image forming part 7 is wound around the heat drum 41 between the upstream-side and downstream-side tension rollers 43 and 45. The heat drum 41 is heated to heat the printing base material M conveyed along the surface.

Next, the rewinding roller 11 will be described. The end of the printing base material M is fixed to the rewinding roller 11. The rewinding roller 11 is connected to a motor (not shown) and is rotated. By rotating the rewinding roller 11 in a predetermined direction at a predetermined rotational speed by the motor, the printing base material M is fed out from the feed roller 3. The fed printing base material M passes through the precoating unit 5, the image forming part 7, and the drying part 9, and is wound around the rewinding roller 11.

Next, the conveying plate 13 will be described. As shown in FIG. 1, the conveying plate 13 is disposed below the precoating unit 5 and the image forming part 7. The upper surface of the conveying plate 13 is formed flat. As shown in FIG. 2, a width of the conveying plate 13 is larger than a width of the printing base material M and all the head units 21 and 31. A heat source (not shown) is provided below the conveying plate 13 to heat the conveying plate 13 to a predetermined temperature. The conveying plate 13 is made of metal, for example.

Next, the control part 51 will be described. As shown in FIG. 1, the control part 51 controls the precoating head unit 21 of the precoating unit 5 and the four image forming head units 31 of the image forming part 7. To the control part 51, image data of an image to be printed is input. The control part 51 determines whether the adjacent pixels (dots) have the same color or different colors based on the input image data.

The image forming operation of the inkjet image forming apparatus 1 having the above configuration will be described. In the image forming operation, the image data is input to the control part 51. The control part 51 determines whether the adjacent pixels have the same color or different colors based on the image data.

Thereafter, the motor is driven to rotate the rewinding roller 11, and the printing base material M is fed out from the feed roller 3. When the printing base material M reaches below the precoating unit 5, the precoating liquid is ejected from the print heads 23 of the precoating head unit 21 of the precoating unit 5 to the printing base material M. At this time, the control part 51 controls the precoating unit 5 such that an amount of the precoating liquid ejected to a region where the adjacent pixels have different colors is larger than an amount of the precoating liquid ejected to a region where the adjacent pixels have the same color. As an example, an amount of the ejected precoating liquid per unit area to the region where the adjacent pixels have different colors is 1.5 to 2 times an amount of the ejected precoating liquid per unit area to the region where the adjacent pixels have the same color. The amount of the ejected precoating liquid per unit area to the region where the adjacent pixels have the same color is an amount set at the time of normal precoating treatment.

One pixel is formed by the ink ejected from one nozzle of the print head 33 of the image forming head unit 31. Therefore, the control part 51 determines whether the adjacent pixels have the same color or different colors based on the image data. When it is determined that the adjacent pixels have the different colors, the precoating unit 5 is controlled to increase an amount of the precoating liquid ejected from the nozzles corresponding to the adjacent pixels. Specifically, a voltage applied to the piezoelectric element provided in the nozzle is increased. The amount of the precoating liquid may be increased not only for the two adjacent two pixels but for a predetermined range including the two adjacent pixels.

Thereafter, the printing base material M is conveyed below the image forming part 7. In the image forming part 7, based on the image data, the ink of the predetermined color is ejected from the print heads 33 of the image forming head unit 31 to form an image on the printing base material M. The printing base material M on which the image is formed is conveyed to the drying part 9. In the drying part 9, the image (the ink) is completely dried. Thereafter, the printing base material M is wound by the rewinding roller 11.

As described above, according to the present disclosure, an amount of the precoating liquid ejected to the regions where the adjacent pixels have different colors is larger than an amount of the precoating liquid ejected to the regions where the adjacent pixels have the same color.

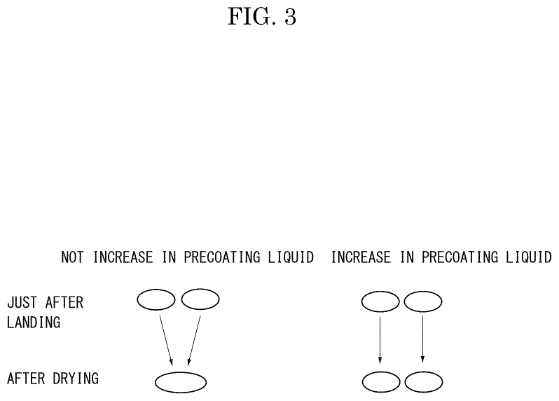

In general, the printing base material M having a low surface tension, such as a plastic film, has a low and stable surface energy so that a droplet of the landed ink easily moves from the landed position on the printing base material M. As a result, as shown in the left view of FIG. 3, the two adjacent ink droplets may be attracted to form one large droplet after drying. When the two adjacent droplets have different colors, the two inks are mixed to form a single droplet of mixed color. Then, a boundary between the images of different colors is blurred and the image quality deteriorates. On the other hand, when the precoating treatment is performed, the adhesion between the ink and the printing base material M is enhanced, and the droplet of the landed ink hardly moves from the landed position on the printing base material M. As a result, as shown in the right side view of FIG. 3, the two ink droplets fit into the printing base material M, and are not attracted to each other. Therefore, the inks of the two colors are hardly mixed.

Further, by setting an amount of the precoating liquid ejected to the region where the adjacent pixels have different colors to be larger than an amount of the precoating liquid in the normal precoating treatment, the color mixing can be prevented without unnecessarily increasing an amount of the precoating liquid to be used.

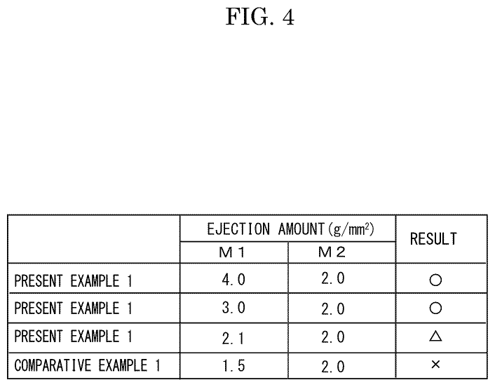

Next, a test in which a degree of the color mixing is evaluated in the inkjet image forming apparatus 1 of this embodiment will be described with reference to the table in FIG. 4. FIG. 4 is a table showing the color mixing (bleeding) in the present example and the comparative example. A test image in which cyan and magenta rectangular solid images are adjacently arranged each other is printed on an OPP film at 600 dpi. After the ink is dried, the boundary portions of both the images of the test image are visually observed using a microscope (Product name, MM-800, manufactured by Nikon), and those in which no color mixing is observed are shown by “o”, those in which the color mixing width is less than 10 μm are shown by “Δ”, and those in which the color mixing width is 10 μm or more are shown by “X”.

In the present examples 1 to 3, as described above, the precoating treatment is performed so that an amount (M1) of the precoating liquid ejected to the regions where the adjacent pixels have different colors is larger than an amount (M2) of the precoating liquid ejected to the regions where the adjacent pixels have the same color. A ratio of an amount of the precoating liquid per unit area ejected to the region where the adjacent pixels have different colors to an amount of the precoating liquid per unit area ejected to the regions where the adjacent pixels have the same color is 2 in the present example 1, 1.5 in the present example 2, and 1.05 in the present example 3.

On the other hand, in the comparative example 1, an amount of the precoating liquid per unit area ejected to the regions where the adjacent pixels have the same color is smaller than an amount of the precoating liquid per unit area ejected to the regions where the adjacent pixels have the same color. In the present examples and the comparative example, the ejection amount is adjusted by a voltage applied to the piezoelectric element of the print head. The ejection amount is obtained by dividing a difference in the weight of the printing base material before and after the ejection of the precoating liquid by an ejection area.

As shown in the table of FIG. 4, no color mixing is observed in the present examples 1 and 2, and a degree of the color mixing is low in the present example 3. That is, it can be seen that the ejection amount of the precoating liquid is increased in the region where the adjacent pixels have different colors, so that it is difficult for the ink to move from the landed position as described above, thereby reducing the color mixing. Further, P it can be seen that the ratio of the ejection amount is preferably 1.5 to 2 (the present examples 1 and 2).

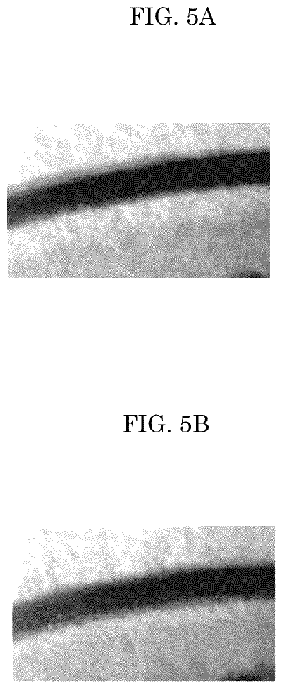

Other test results will be described with reference to FIG. 5A and FIG. 5B. A test image in which the adjacent images have different colors is printed at 600 dpi. FIG. 5A shows the printed test image of the present example in which the precoating treatment is performed in which an amount of the precoating liquid ejected to the regions where the adjacent pixels have different colors is larger than an amount of the precoating liquid ejected to the regions where the adjacent pixels have the same color, and FIG. 5B shows the printed test image of the comparative example in which the precoating treatment is performed in which a fixed amount of the precoating liquid is ejected regardless of the color of adjacent pixels.

As shown in FIG. 5A, in the present example, the boundaries of the images of different colors are distinct. On the other hand, as shown in FIG. 5B, in the comparative example, it can be seen that the boundaries of the images of different colors are blurred and mixed.

In the above embodiment, the image forming head unit 31 of the four colors is used, but the present disclosure is not limited to the four colors and may be more or less than four colors. The head units 21 and 31 are not limited to the line head system. However, the line head system is preferable because the printing speed can be increased. Although a long plastic film (PET film) is used as the printing base material M, a cut film may be used.

Although the present disclosure has been described in particular embodiments, the present disclosure is not limited to the foregoing embodiments. A person skilled in the art may modify the above embodiments so long as they do not deviate from the scope and object of the present disclosure.

1. An inkjet image forming apparatus comprising:
an image forming part which ejects ink on a printing base material conveyed in a predetermined conveyance direction, based on image data to form an image;
a precoating unit which is arranged on an upstream side of the image forming part in the conveyance direction, and performs a precoating treatment in which a precoating liquid is ejected on the printing base material; and
a control part which controls an amount of the precoating liquid ejected by the precoating unit, wherein
the control part increases an amount of the precoating liquid ejected to a region where adjacent pixels have different color compared with an amount of the precoating liquid ejected to a region where adjacent pixels have the same color.

2. The inkjet image forming apparatus according to claim 1, wherein
the control part determines whether the adjacent pixels have the different colors or not, based on the image data.

3. The inkjet image forming apparatus according to claim 1, wherein
the image forming part includes a head unit which ejects the ink,
the precoating unit includes a head unit which ejects the precoating liquid, and
both the head units have the same structure.

4. The inkjet image forming apparatus according to claim 1, wherein
the printing base materials is a plastic film.
